(19) United States
(12) Patent Application Publication
(10) Pub. No.: US 2007/0083936 A1
(43) Pub. Date: Apr. 12, 2007

(54) Methods and apparatuses for authorizing use of an information processing feature

(76) Inventors: Robert C. Booth, Ivyland, PA (US); Richard P. Rementilla, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/236,338

(22) Filed: Sep. 27, 2005

(51) Int. Cl. H04L 9/32

(52) U.S. Cl. 726/27

(57) ABSTRACT

A method for authorizing use of an information processing feature (“IPF”) (12, 13) with an information processing device (“IPD”) (14). The method includes receiving a data structure (20), which includes a first data portion (402) having information identifying the IPF, identifying a hash algorithm (405), and identifying an access condition (408) usable to provide a logical reference to one or more feature-enabling criteria (393). The data structure also includes a second data portion (404) having information identifying a hash value. The method further includes accessing the feature-enabling criteria, and applying the hash algorithm to at least part of the information in the first data portion to derive the hash value. Based on the derived hash value, authorization to use the IPF with the IPD is obtained.

### BACKGROUND

Operators of wired and wireless broadband communication systems, such as cable networks, satellite networks, telecommunication networks, Internet networks, wide area networks, fiber-optic networks, copper wire networks and the like, deliver digital media such as video, audio and/or data via a variety of transmission media to consumers. Consumers purchase at retail and/or lease from system operators an assortment of information processing devices having digital decoders to receive and/or render the delivered digital media, such as all types of stand-alone and built-in set-top boxes, cable modems, media centers, hard disk drives, digital receiving, recording and playback devices, personal computers, telecommunication devices, digital televisions, gateways, routers, and wireless access points, among other things.

Consumer information processing devices (“consumer devices”) generally include software, firmware, middleware, and hardware platforms—such platforms comprise the underlying system(s) and components that determine the features and functionality of the consumer devices. Consumer devices with feature-rich platforms are generally the most expensive—for both consumers and system operators providing such devices to their customers. Although consumer devices having platforms with fewer features and functions may be initially less expensive than devices with feature-rich platforms, such lower-end devices often require repeated replacement or upgrades (at both the device- and system-level), resulting in additional cost and inconvenience associated with their use. For example, when a customer of a subscription television service offered by a cable or satellite company wishes to receive new communication options or services, it is often necessary to obtain an entirely new consumer device, such as a set-top box, and to endure the technical and service hassles associated with obtaining the new device. In addition, consumers often must pay for and receive unwanted content or services (television channels, for example) that are bundled with the content or services they wish to receive.

There are therefore needs for flexible, scalable, and secure methods and apparatuses for selectively enabling specific features or functions of feature-rich consumer devices, which would benefit manufacturers, system operators, and consumers alike. System operators would be allowed to pay manufacturers only for certain features or functions of consumer devices, thus enabling operators and customers to purchase such devices at lower price points initially, and, based on a determination of customer demand, subsequently selectively enable additional features or functions on the same consumer devices.

### BRIEF DESCRIPTION OF THE DRAWINGS

FIG. 1 is a block diagram illustrating elements of a system for authorizing use of an information processing feature with an information processing device.

FIG. 2 is a block diagram of a generic network device, illustrating certain components that are accessible by, or included in, the various devices shown in FIG. 1

FIG. 3 is a block diagram of the information processing device shown in FIG. 1.

FIG. 4 illustrates the data structure associated with the feature authorization key shown in FIG. 1.

FIG. 5 is a flowchart of a method for authorizing use of an information processing feature with an information processing device.

### DETAILED DESCRIPTION

A method for authorizing use of an information processing feature (such as a service, a computer program, a tier, or an operational mode) with an information processing device (such as a decoder associated with a consumer network device like a cable set-top box or a terrestrial set-top box) operable to respond to a broadband communication system (such as a broadband network (e.g., a cable television network), a broadband network device, or an operator of a broadband network) via a communication medium (such as a channel signal, a data signal, or a computer-readable storage medium) is provided. An information processing feature is a particular data processing capability associated with a device. Authorization to use the information processing feature is the determination of the right or permission to use the feature; and the process of granting access to its use.

The method includes a first step of accessing a data structure. The data structure itself includes a first data portion having information identifying the information processing feature, identifying a hash algorithm, and identifying an access condition associated with the information processing feature.

The access condition, which defines a restriction regarding use of the information processing feature, is usable to provide a logical reference to one or more feature-enabling criteria. The access condition takes the form of a Boolean expression of logical references to feature-enabling criteria. Instead of using actual feature-enabling criteria in the access condition, it may be desirable to instead use variables that represent the feature-enabling criteria. Feature-enabling criteria are a subset of configuration information. Both feature-enabling criteria and configuration information are characteristics associated with the information processing device. The data structure also includes a second data portion having information identifying a hash value, which is derived by applying the hash algorithm to at least part of the information in the first data portion. The hash algorithm is also applied to at least some of the feature-enabling criteria.

Next, the feature-enabling criteria are accessed, and are used in applying the hash algorithm to at least part of the information in the first data portion to derive the hash value identified in the second information portion.

Once the hash value has been successfully derived, the hash value is used to obtain authorization to use the information processing feature with the information processing device. For example, at least part of the data structure may be transferred to a security element within the information processing device. The security element would use other information and methods specific to the broadband communication system to provide authorization to use the information processing feature.

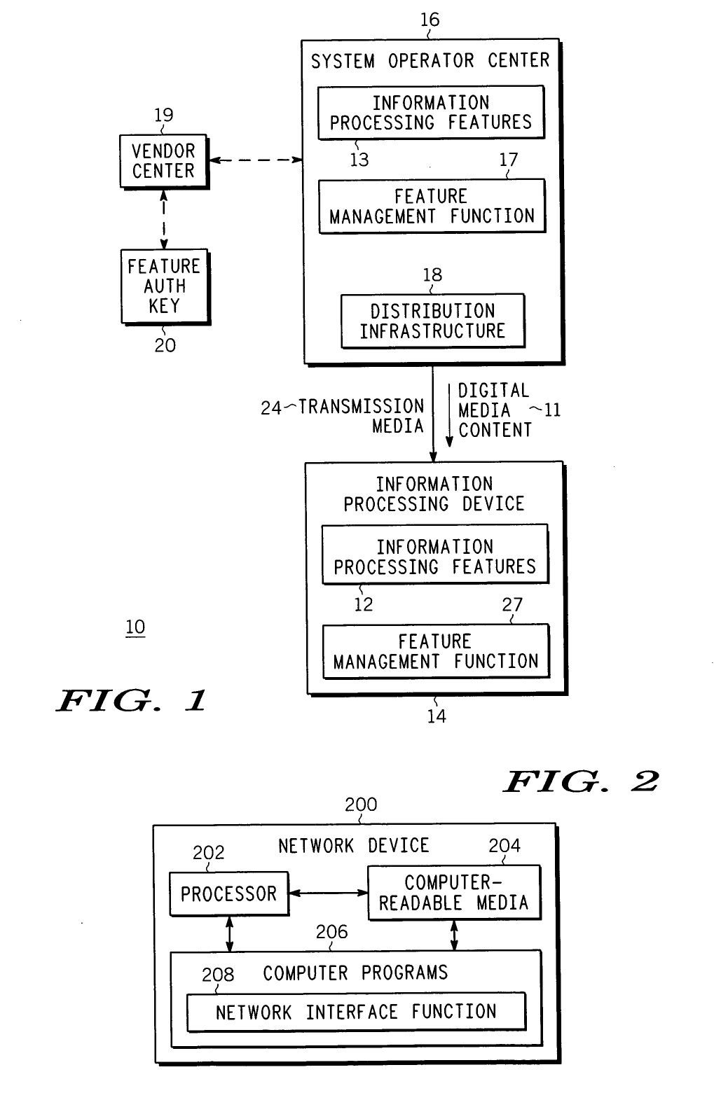

Turning now to the drawings, wherein like numerals designate like components, FIG. 1 is a block diagram illustrating elements of a system 10 for authorizing use, via a feature authorization key 20, of one or more information processing features 12, 13 with an information processing device 14. Information processing features 12 are specific capabilities of information processing device 14, such as two-way interactive capabilities, access to certain television channels or services, telecommunication capabilities, Internet capabilities, and access to other specific features or functions of information processing device 14, whether now known or later developed. Information processing features 13 are specific capabilities of a system operator center 16 and/or services provided thereby, such as two-way interactive services, access to certain television channels or services (tiers, for example), and access to other specific products or services (such as computer programs, Internet services, and telecommunication services) offered by the system operator center, whether now known or later developed.

As shown, system 10 includes various elements, shown in simplified form. System operator center 16 delivers digital media content 11 to information processing device 14 via one or more transmission media 24 and distribution infrastructure 18. Digital media content 11 is any pre-recorded or live digital electronic signals representing an image and/or audio, software, or other data (including feature authorization key 20), in any format.

System operator center 16 controls access to information processing features 12 and 13 via feature management function 17. A vendor center 19, such as an equipment manufacturer, content/service provider, or other third party generates feature authorization key 20 for delivery to system operator center 16. Information processing device 14, is, among other things, operable to respond to system operator center 16 via one or more transmission media 24 to receive digital media content 11 and to access information processing features 12, 13 via feature management function 27. Feature authorization key 20 itself is a data structure usable to enable information processing device 14 to use or access one or more information processing features 12, 13.

For exemplary purposes, system operator center 16 is a regional headend associated with a hybrid fiber-optic/coaxial cable network operated by a multiple service operator (“MSO”). Transmission media 24 represents a hybrid fiber-optic/coax network providing one- or two-way communications services such as interactive television, Internet services, telephone services, video-on-demand services, and other services now known or later developed to information processing devices at consumer locations, such as information processing device 14. Information processing device 14 is a cable or terrestrial set-top box (for example, a set-top box from Motorola's DCT700 series of cable receivers) located in or around a customer location such as a home, vehicle, business, or other consumer space.

FIG. 2 is a block diagram of a generic network device 200 that has functional components generally included in, or accessible by, elements (and one or more components thereof) associated with system 10. For example, components of generic network device 200 can be included in or accessible by vendor center 19, system operator center 16, and information processing device 14. A processor 202 is responsive to computer-readable storage media 204 and to computer programs 206. Computer-readable storage media may be any number and combination of local or remote devices, now known or later developed, capable of recording or storing data, and in particular may be, or may include, a read only memory (“ROM”), a flash memory, a random access memory, any type of programmable ROM (“PROM”), a hard disk drive, any type of compact disk or digital versatile disk, a magnetic storage device, or an optical storage device.

Computer programs 206 are generally software components implemented according to well-known software engineering practices for component-based software development and stored in computer-readable media, such as computer-readable storage media 204. Computer programs 206, however, may be any signal processing methods and/or stored instructions, in one or more parts, in software, hardware, or firmware or any combination thereof, that electronically control functions set forth herein.

Network interface function 208 represents aspects of the functional arrangement of various computer programs 206 that pertain to the receipt and processing of digital media content 11 (shown in FIG. 1), and messages relating thereto, as such content traverses paths of network devices, passing through, at each network interface, the seven vertical layers of the well-known abstract model that defines internetworking: layer 1, the Physical Layer; layer 2, the Data Link Layer; layer 3, the Network Layer; layer 4, the Transport Layer; layer 5, the Session Layer; layer 6, the Presentation Layer; and layer 7, the Application Layer. Among other things, network interface function 208 facilitates communication between functions such as feature management function 17 (shown in FIG. 1) and feature management function 27 (also shown in FIG. 1). As such, network interface function 208 may include data interfaces, operations support interfaces, radio frequency interfaces, and the like (implemented, for example, by routers, switches, modems, or other network connection support devices or software at each network device configured to handle communication protocols).

Referring again to FIG. 1, during general operation, system operator center 16 facilitates transfer of digital media content 11 to information processing device 14 using distribution infrastructure 18. System operator center 16 may also be in communication with a billing system (not shown) to establish security associations between system operator center 16 and information processing device 14.

Distribution infrastructure 18 includes a collection of well-known reception and retransmission equipment (such as servers/controllers, multiplexers, modulators, routers, and network adapters and/or interfaces) that operate in well-known manners to manage and control the processing of digital media content 11, in either a secure or non-secure fashion, for delivery via one or more transmission media 24 to information processing device 14. In-band and out-of-band messages may be used to communicate with, and provision services to, information processing device 14. Distribution infrastructure and components thereof may include or access one or more instances of the functional components shown and described in connection with FIG. 2.

In general, feature management function 17 manages feature authorization key(s) 20. Feature authorization key(s), which are discussed in more detail below, are used to turn particular information processing features 12, 13 on or off. More specifically, feature management function 17, which may be implemented by one or more Application Layer computer programs, represents functions relating to the handling and distribution of feature authorization key 20 to information processing device 14, and enabling use of specific information processing features 12, 13 with information processing device 14. Feature management function 17 may communicate with multiple applications at various layers. For example, feature management function 17 may be responsible for performing various functions such as receiving, storing and transmitting feature authorization key 20 to select information processing devices.

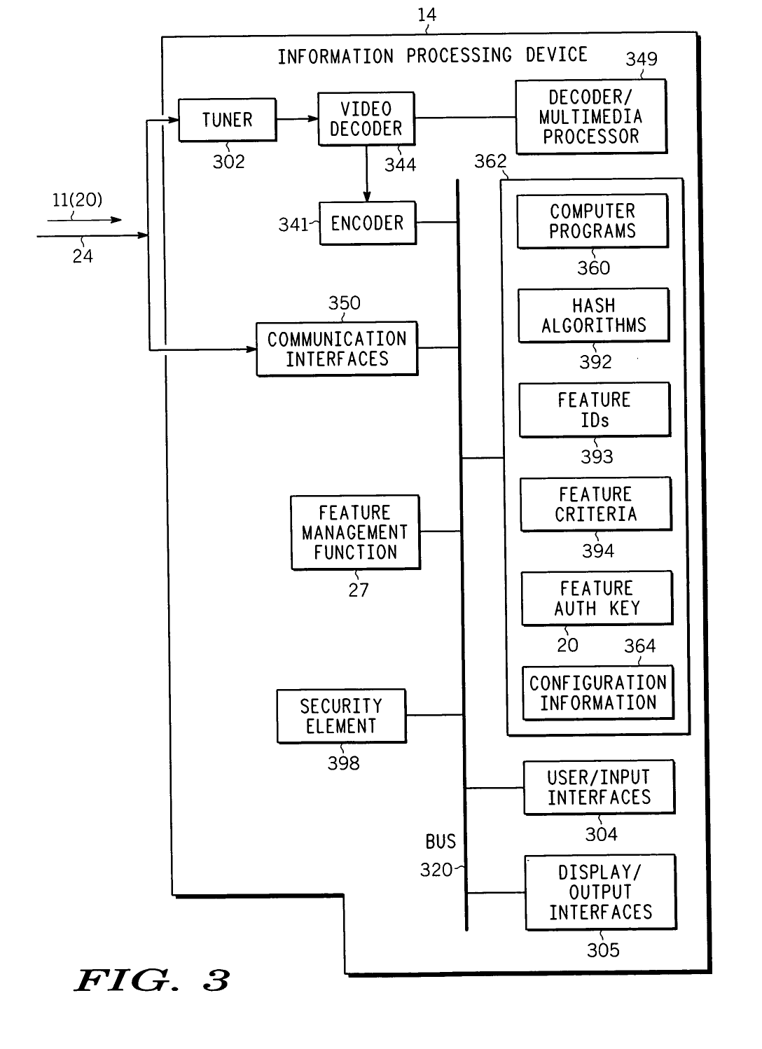

FIG. 3 is a block diagram of an exemplary information processing device 14, such as a stand-alone or embedded, cable or terrestrial, set-top box, which includes or accesses the components of generic network device 200 (shown in FIG. 2. Using one or more channels, protocols and/or techniques, information processing device 14 receives information (digital media content 11, for example) from—and if so configured may communicate information to—system operator center 16 (shown in FIG. 1) via transmission media 24. Such information has generally been selected or requested by a consumer (not shown) using any type of well-known user/input interface 304 such as a remote control, mouse, stylus, microphone, keyboard, or display.

In one example, information processing device 14 receives a channel signal carrying products or services offered by operator of system operator center 16. In another example, information processing device 14 receives a feature authorization key 20 from system operator center 16, which enables the use of specific information processing features 12, 13 with information processing device 14.

Digital media content 11 may be received via tuner 302. Tuner 302 includes well-known arrangements of components, which operate by tuning to a particular in-band or out-of-band channel signal using well-known manners and techniques. Digital media content 11 may also be received at communication interface(s) 350, which facilitate one- or two-way communication with other internal or external devices or networks thereof. Other elements associated with information processing device 14 include one or more internal buses 320, which are well-known and widely available elements that carry data, addresses, control signals and other information within, to, or from information processing device 14. Display/output interfaces 305 receive and/or render information output from information processing device 14 using well-known methods and techniques.

A video decoder 344 is responsive to receive and decode video signals from tuner 302. Video decoder 344 includes well-known arrangements of components, such as demodulators, responsive to receive digital signals, such as digital data packets of digital data media 11, and to output video information. Video information that may require format translation or modification for compatibility with features and functions of information processing device 14 (such as information processing features 12) and peripherals thereof (not shown) may be passed to encoder 341 for formatting. Encoder 341 includes well-known arrangements of components, and operates in accordance with well-known methods and techniques.

Video information from video decoder 344 and/or encoder 341 may be passed to decoder/multimedia processor 349, which is operative to perform predetermined coding techniques to arrange video information into displayable/storable formats, in accordance with well-known methods and techniques. Internal arrangements of multimedia processor 349 are well known.

Block 360 illustrates certain aspects of the functional arrangements of computer programs 206 (shown in FIG. 2). The functions shown in block 360 relate to how feature authorization key 20 is used to authorize information processing device 14 to use certain information processing features 12, 13.

Feature management function 27, which may be implemented by one or more Application Layer computer programs, represents functions relating to the handling and processing of feature authorization key 20 by information processing device 14. For example, feature management function 27 may be responsible for performing various functions such as receiving, storing, and decoding feature authorization key 20. Feature management function 27 may communicate with other applications, such as feature management function 17 (an application is a software program that provides certain functionality) at various layers. Security element 398 is operable to receive aspects of decoded feature authorization key 20 from feature management function 27, and to facilitate access to hardware, software and/or firmware configured to activate certain information processing features 12, 13.

Block 362 illustrates examples of data that may be stored in various computer readable media 204 (shown in FIG. 2). The stored data relates to information processing device's 14's authorization to use certain information processing features 12, 13 associated with the various features and functions supported by information processing device 14 and system operator center 16, respectively. Such data may include, but is not limited to: (1) feature authorization key 20 itself; (2) executable instructions associated with computer programs 360 that are performed by processor 202 (shown in FIG. 2); and (3) information accessible by computer programs 360 that is used in the handling and processing of feature authorization key 20.

The information accessible by computer programs 360 is discussed in further detail below, and includes: (a) a hash algorithm 392; (b) representations of a set of feature identifiers 393 associated with information processing features 12, 13 (feature identifiers are codes, such as names or numbers, that represent specific information processing features 12, 13); (c) representations of a set of one or more feature-enabling criteria 394 associated with each feature identifier 393; and (d) representations of certain configuration information 364 associated with information processing device 14. As discussed above, configuration information 364 represents a characteristic of information processing device 14 that may be used to enable or disable any specific feature, and feature-enabling criteria 394 are a subset of configuration information. More specifically, feature-enabling criteria 394 associated with a particular feature identifier 393 are the select subset of configuration information 364 needed to implement the specific feature 12,13 represented by the feature identifier. Examples of configuration information 364 include, but are not limited to, platform identifiers, software, hardware and firmware versions, decoder states, tier information, and user- and system-defined configuration settings (such as communication settings, network settings, site identifiers, device characteristics, Internet Protocol (“IP”) addresses, and realm/domain names and the like).

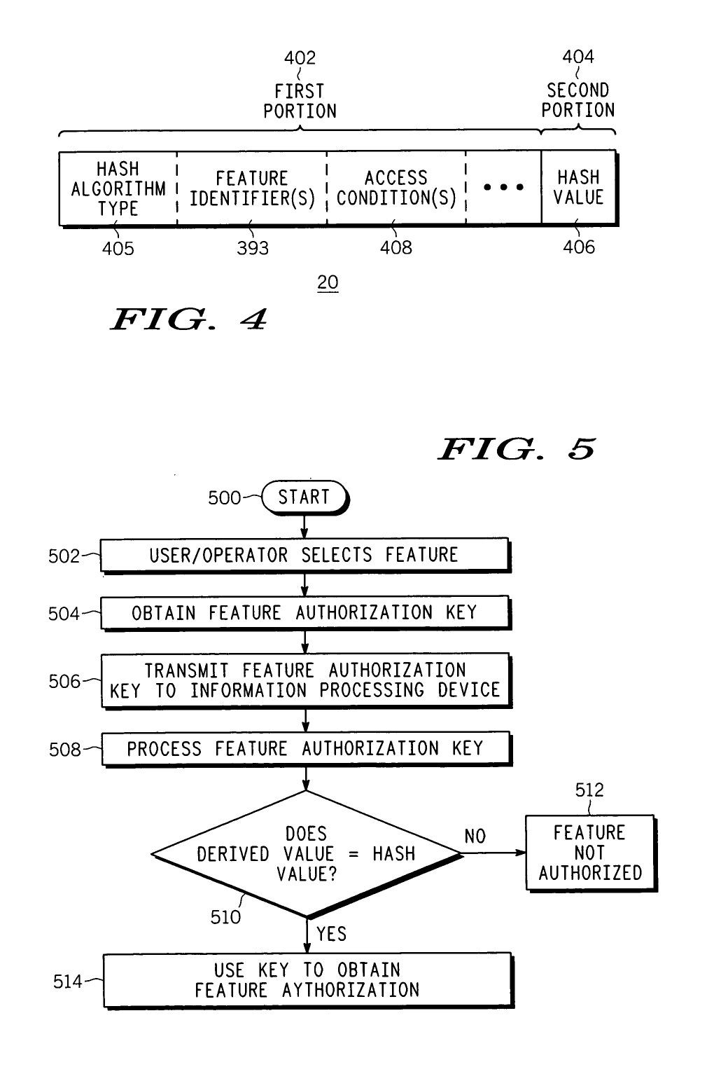

FIG. 4 illustrates an exemplary data structure implementation of feature authorization key 20. Key 20 includes a first portion 402 (a data structure ‘K’ bytes long) and a second portion 404 (a data structure ‘S’ bytes long). First portion 402 is a header portion, which, among other things, identifies the type 405 of hash algorithm 392 (shown in FIG. 3) used to create a hash value 406. First portion 402 also identifies various other items. Feature identifiers 393 (first shown in FIG. 3), identify specific information processing features selected to be enabled or disabled via feature authorization key 20. An access condition 408 (associated with each feature identifier 393) provides a logical reference to one or more feature-enabling criteria 394 (first shown in FIG. 3).

With continued reference to FIG. 4, a detailed example of the data format of an exemplary feature authorization key header portion 402 is provided in Table 1. “Enable” is a 1-bit field that, if set to a predetermined value of ‘0’ or ‘1’ indicates that the information processing features identified in the “feature_count” field should be enabled or disabled, according to the meaning assigned to the predetermined value. “Global_key” is a 1-bit field that, if set to a predetermined value of ‘0’ or ‘1’ indicates that the feature-enabling criteria 394 to which the logical reference(s) of access condition 408 correspond (set forth in the “feature_key_criteria” field) represents a global enabling of all of the information processing features identified in the “feature_id” field of the current feature authorization key header portion 402. “Key_algorithm” is a 3-bit field that represents the type of hash algorithm 392 (shown in FIG. 3; for example, CRC32 or MD5) used to create hash value 406.

“ROM_ID” is a 16-bit field that represents the platform associated with information processing devices to which feature authorization key 20 is applicable. Likewise, “firmware_version_xx” is an 8-bit field that represents the first component of the platform firmware version, and “firmware_version_yy” is an 8-bit field that represents the last component of the platform firmware version. If xx and yy are both set to 0xFF, then feature authorization key 20 is applicable to all firmware versions for the platform specified in the “ROM_ID” field.

“Feature_count” is an 8-bit field that indicates the number of information processing features (referred to by feature identification values 393) in the “feature_id” field. “Feature_id” is an 8-bit field that includes feature identification values 393 referring to specific information processing features enabled/disabled via the current feature authorization key 20. Feature identification values 393 are generic by design so that they may represent functions associated with hardware, firmware, and software, applications, application features, or any part thereof.

The “Criteria_term” field may include logical references to up to 20 feature-enabling criteria 394, which, together with Boolean operands, define access condition 408 associated with a particular feature identifier 393. An access condition within the criteria_term field is processed by information processing device 14 to determine permitted uses/restrictions (for example, site restrictions, geographical restrictions, and device-type restrictions) of specific information processing features represented by specific feature identification values 393. The following C-language statement is a sample definition of the criteria_term variable type: crtieria_term {A,B,C,D,E,F,G,H,I,J, resvd1, and, or, not, eol, resvd2}.

Terms A through J are logical references (such as variables) to feature-enabling criteria 394 associated with a specific feature_id. As discussed above, feature-enabling criteria 394 are the select subset of configuration information 364 needed to implement the particular feature represented by a specific feature_id—each feature-enabling criteria 394 represents a characteristic associated with the information processing device, such as particular configuration information 364. The “AND” and “OR” terms are binary operators that may replace the top two Boolean variables on an evaluation stack with the logical AND or OR of the two, accordingly. The “NOT” term is a unary operator that may replace the Boolean variable on top of the stack with its logical opposite. The “EOL” term terminates the equation and indicates that the top of the stack is to be interpreted as the result. An expression of a number of terms may be defined (20 terms, for example, in which case the “EOL” term would not appear and is assumed to be the 21^{st} term). An information processing device may consider the entire expression to be false if any criteria_term has predetermined reserved values in the enumeration (0xA or 0xF, for example). In this manner, for each feature/feature_id, an access condition expression may be created using variables corresponding to feature-enabling criteria, rather than using the feature-enabling criteria themselves. The criteria_term field may be read, and the logic associated therewith applied, via feature management function 27 and/or security element 398. Because actual feature-enabling criteria 394 need not be sent in feature authorization key 20 (they are accessible by information processing device 14), the security of key 20 is enhanced.

TABLE 1

| | | | | Bit number/ |
|---|---|---|---|---|
| feat auth key header( ) { | | Bits | Bytes | Description |
| | feature_key_type | 8 | 1 | |

| reserved | 3 | 5-7: reserved |
|---|---|---|
| enable | 1 | 4: enum {disable, |
| | | enable} |
| global_key | 1 | 3: enum {no, yes} |
| key_algorithm | 3 | 0-2: (see below) |

| | | |
|---|---|---|
| ROM_ID | 16 | 2 |
| firmware_version | 16 | 2 |

| | | |
|---|---|---|
| xx | 8 | 1 |
| yy | 8 | 1 |

| | | | |
|---|---|---|---|
| feature_count | 8 | 1 | range: 0 to 100 (N) |
| for (i=0; i < feature_count; i++) | | | |

| | | |
|---|---|---|
| feature_id | 8 | 1 |
| for (k=0; k < 20; k++) { | | |

| | | |
|---|---|---|
| criteria_term | 4 | (0.5) |

}

}

}

Referring again to FIG. 4, second portion 404 of feature authorization key 20 identifies hash value 406, which is derived by applying the hash algorithm identified by field 405 to first portion 402 (or parts thereof) and to feature-enabling criteria 394 to which the logical reference(s) of access condition(s) 408 within the criteria_term field correspond. When the actual feature-enabling criteria 394 are not sent in feature authorization key 20, they are accessed by information processing device 14 and inserted in place of the logical references present in the criteria_term field prior to the hash algorithm being applied.

An example of a data structure that may be used to create feature-enabling criteria 394 from which hash value 406 is derived is set forth in Table 2. Any type of information may be defined for specific feature-enabling criteria 394—configuration information 364 (shown in FIG. 3), for example, may form the basis for certain feature-enabling criteria.

TABLE 2

| feature_enabling_criteria( ) | | | | Bit number/ |
|---|---|---|---|---|
| { | | Bits | Bytes | Description |
| for (i=0; i < feature_count) { | | | | |
| | criteria_count | 8 | 1 | |
| | for (i=0; i < criteria_count) { | | | |

| | | | |
|---|---|---|---|
| criteria_type | 8 | 1 | |
| criteria_size | 8 | 1 | N |
| criteria_data | 8*N | N | |

}

}

}

“Criteria_count” is an 8-bit field that represents the number of feature-enabling criteria 394 that following the data structure. “Criteria_type” is an 8-bit field that indicates the type of data contained in the “criteria_data” field that follows. The “criteria size” field is an 8-bit field that indicates the size of the “criteria_data” field that follows. “Criteria_data” is a variable length field of up to 256 bytes that defines the data of the type specified by the criteria_type field.

Referring again to FIG. 4, hash algorithm 392 used to create hash value 406 may be any well-known/widely available algorithm—for example, a CRC32 cyclic redundancy check algorithm and an MD5 message-digest algorithm produce 32-bit and 128-bit encrypted values, respectively, that may be used to form second portion 404 and be backwards-calculated by information processing device 14 (via feature management function 27, for example) to obtain the original data.

With continued reference to FIGS. 1 through 4, FIG. 5 is a flowchart of a method for authorizing use of an information processing feature, such as information processing features 12 or 13, with an information processing device, such as information processing device 14. The information processing device is operable to respond to a broadband communication system, such as system operator center 16, via a communication medium, such as transmission media 24. The method may be implemented when one or more computer programs, such as computer programs 206 associated with vendor center 19, system operator center 16, or information processing device 14 (for example, feature management functions 17 and/or 27) are loaded into a processor, such as a processor associated with system operator center 16 or information processing device 14, and executed.

The method begins at block 500, and continues at block 502, where a user/operator selects a particular feature 12, 13 for use with a certain information processing device, such as information processing device 14. At block 504, a feature authorization key, such as feature authorization key 20, is obtained.

In implementation within system 10, feature authorization key 20 is created by vendor center 19 and forwarded to an entity (such as system operator center 16) that authorizes use the features with information processing device 14.

Feature authorization key 20 is a data structure having the format shown in FIG. 4. When feature authorization key 20 is destined for use by information processing device 14, for example, some or all of the information in first portion 402, such as the ROM_ID and firmware_version fields shown in Table 1, may be populated with configuration information 364, such as the geographic area/site ID of information processing device 14 and/or system operator center 16, the class of set-top box information processing device 14 belongs to, identifiers of particular software, firmware, or hardware in use by information processing device 14, and the like. Features being enabled or disabled are identified using predetermined feature identifiers, and for each feature identified in the feature_id field, an access condition 408 expression in the criteria_term field logically references one or more feature-enabling criteria 394.

Feature identifiers 393 (codes, such as names or numbers, that represent specific information processing features 12, 13) are used to identify the particular feature(s) that is/are being turned on or off. For each feature identifier, feature-enabling criteria 394 are assembled—feature-enabling criteria are the select subset of configuration information 364 needed to implement the feature represented by the feature identifier.

An access condition 408 is created from the feature-enabling criteria 394. To enhance security of key 20, instead of using the feature-enabling criteria themselves to form access condition 408, logical references (variables, for example) to the feature-enabling criteria may be used. The access condition indicates permitted uses/restrictions (for example, site restrictions, geographical restrictions, and device-type restrictions) of particular features represented by feature identifiers 393. The access condition is generally a Boolean expression of a number of feature-enabling criteria, although the access condition may contain one or no feature-enabling criteria, and simply serve as an indicator of universal applicability.

A hash algorithm 392 is identified in the key_algorithm field. Hash algorithm 392 is applied to at least some of the information in first portion 402 of feature authorization key 20, along with at least some of the relevant feature-enabling criteria 394, to derive hash value 406. Hash value 406 is appended to first portion 402 of feature authorization key 20 to form second portion 404 of feature authorization key 20.

At block 506, the feature authorization key is transmitted to the information processing device.

Use and distribution of feature authorization key 20 by system operator center 16 is handled by feature management function 17. Feature authorization key 20 may be delivered to information processing device 14 in a variety of ways. In one example, a digital message, such as a new DCT MSP configuration subcommand, from a digital addressable controller (“DAC”) may be used to deliver feature authorization key 20 to information processing device 14 via a channel signal. A “site config” subcommand and/or a “feature key config” subcommand may specify the site with which information processing device 14 is associated with, for example.

In another example, a channel map overloading mechanism allows an operator of system operator center 16 to enter feature authorization key 20 as the source name of a background service—information processing device 14 would search new channel maps, which arrive at predetermined locations/intervals in channel signals, for source names that start with a particular ASCII string, such as “KEY:”. An exemplary channel map overload message is shown in Table 3. The “cmo_tag” field, or channel map overload tag field, is a 32-bit field that may be set to a particular ASCII text string, such as “KEY:” (0x4B4559). The field labeled “hex_cmo_type” is a 16-bit field storing the ASCII representation of the enumerated hex value of the type of data that follows in the “hex_cmo_data( )” field. The hex_cmo_type field is one of the following: feature_key (an ASCII field that is twice the length of the corresponding feature authorization key 20 by converting the data bytes of feature authorization key 20 into a hexadecimal ASCII string—that is, length=2*(K+S)); site_id (an ASCII field that represents in hex format a unique identifier for each controller/system operator center 16 site for which features are to be enabled); and reserved_x02..xFF.

TABLE 3

| chmap_overload_message( ) { | | Bits | Bytes | Bit number/Description |
|---|---|---|---|---|
| | cmo_tag | 32 | 4 | always 0x4B45593A (i.e. |
| | | | | “KEY : ”) |
| | hex_cmo_type | 16 | 2 | |
| | hex_cmo_data( ) | 8*N | N | |

}

The feature authorization key 20 is processed at block 508. At information processing device 14, receipt and handling of feature authorization key 20 is managed by feature management function 27. Once feature authorization feature authorization key 20 has been received, information processing device 14 may filter (using firmware, for example) on the ROM_ID and firmware_version fields to determine whether the key is targeted for information processing device 14. If the information in the ROM_ID and firmware_version fields indicates that the key is destined for information processing device 14, then, at diamond 510, information processing device 14 could proceed to derive hash value 406 using hash algorithm 392 and information regarding actual feature-enabling criteria 394 accessible by information processing device 14. If the derived hash value and hash value 406 do not match, the feature(s) referred to in key 20 may not be used by information processing device 14, as indicated at block 512. Once hash value 406 has been derived successfully, then as indicated at block 514, the information within feature authorization key 20 may be used to provide access to (via security element 398, for example) information processing features 12, 13 to the extent authorized by access condition(s) 408. For example, information processing device 14 may read the criteria_term field, and apply the logic specified by the access condition within the field to the feature-enabling criteria that are present. In this manner, the access condition is used to determine permitted uses/restrictions (for example, site restrictions, geographical restrictions, and device-type restrictions) of specific information processing features represented by specific feature identification values 393 within key 20. Security element 398 may use other information and methods specific to system operator 16 to turn the information processing features on or off in information processing device 14.

Thus, a cost-effective, scalable, and secure solution is provided for selectively enabling use of specific features or functions of information processing devices that are operable to respond to broadband communication systems via various transmission media. A number of different criteria, such as tiers, platform identifiers, firmware versions, any decoder state, or any other configuration information associated with the information processing device, may be used to enable or disable any specific feature or function. Such methods and apparatuses are operable in both one-way and two-way communication systems, and the data structures described herein do not require network security for delivery, enhancing their flexibility.

The methods and apparatuses described herein have many benefits. Manufacturers may realize revenue from system operators such as cable operators, satellite operators, telecommunication companies, and the like—and system operators can reduce costs to their customers—when system operators pay manufacturers for specific features and functions of consumer devices. For example, operators may pay manufacturers only for certain features or functions of consumer devices, thus enabling operators to purchase such devices at lower price points initially, and, based on a determination of customer demand, subsequently selectively enable additional features or functions.

Manufacturers may also realize cost savings by reducing the number of consumer devices they produce. A single feature-rich device having features or functions activated using the methods and apparatuses described may replace multiple devices that were each equipped to perform specific features and functions. A manufacturer may sell one type of set-top box with a number of different features and functions, and depending on the needs of system operators or end-users, obtain revenue when certain features are turned on (or off) using feature authorization keys.

Customers may also benefit directly. For example, when customers have a device provided by a cable, satellite, or phone company with features or functions that can be activated using feature authorization keys, customers can more often retain the same consumer devices in their homes—instead of enduring the technical and service hassles of switching devices—when they desire to receive new communication options or services. Customers may also more easily select and pay for relevant content. Certain content such as channels or services may be quickly and easily activated individually, without the need to obtain additional, unwanted channels or services that are often bundled together in more expensive packages.

System 10 (shown in FIG. 1) has been described for exemplary purposes in terms of a cable network. It will be understood, however, that system operator center 16 and connections throughout (including transmission media 24) may be any public or private, wired or wireless broadband communication system having infrastructure or technology for delivery of digital media 11, including but not limited to a cable network, a satellite network, a telecommunication network, an Internet network, a wide area network, a fiber-optic network, a copper wire network, or any other existing or future transmission infrastructure or technology, or any combination thereof, operated by any type of content provider(s). Transmission media 24 may include any wired or wireless information delivery medium, including but not limited to analog or digital upstream and downstream channels, data signals thereon, and computer-readable storage media such as CD- or DVD-ROMs, disk drives, and the like.

Information processing device 14 may be any device or combination of consumer devices responsive to system operator center 16, including but not limited to a personal or office-based computer system, a hard disk drive, a media center, any type of digital receiving, recording or playback device, a gateway, a digital television/monitor, a cable modem, a telecommunication device, a radiofrequency communication device, a router, a wireless access point, and the like, either standing alone, or included in other devices. Within information processing device 14, communication interface(s) 350 may be or include elements such as cable modems, personal computers, data terminal equipment, telephones, media players, data storage devices, personal digital assistants, or any other network, device or component/combination thereof, along with associated network support devices and/or software. Multimedia processor 349 and elements thereof may take many forms, including analog-to-digital converters, general or special-purpose processors or application-specific integrated circuits such as encoder/decoder pairs (“CODECs”; MPEG CODECs, for example), storage media and/or buffers, along with demultiplexors for demultiplexing and/or synchronizing at least two streams (for example, video and audio).

It will also be appreciated that the methods described herein are not limited to any specific embodiments of computer software or signal processing methods—functions described herein are processes that convey or transform data in a predictable way, and may generally be implemented in hardware, software, firmware, or any combination thereof. Moreover, while certain elements described herein may function as “agents” or “clients”, such elements need not be implemented using traditional client-server architectures in which computer application programs are configured to cause clients, such as consumer devices, to request services from server-based service providers in a network, but may be implemented in any suitable manner.

When one element is indicated as being responsive to another element, the elements may be directly or indirectly coupled. Connections depicted herein may be logical or physical in practice to achieve a coupling or communicative interface between elements. Connections may be implemented as inter-process communications among software processes.

It will furthermore be apparent that embodiments other than the specific embodiments described above may be devised without departing from the spirit and scope of the appended claims, and it is therefore intended that the scope of this invention will be governed by the following claims.

1. A method for authorizing use of an information processing feature with an information processing device, comprising:
receiving a data structure, the data structure comprising
a first data portion having information identifying the information processing feature, identifying a hash algorithm, and identifying an access condition associated with the information processing feature, the access condition providing a logical reference to one or more feature-enabling criteria representing a characteristic associated with the information processing device, and
a second data portion having information identifying a hash value, the hash value derived by applying the hash algorithm to at least part of the information in the first data portion and to at least some of the feature-enabling criteria;
accessing the feature-enabling criteria;
using the accessed feature-enabling criteria, applying the hash algorithm to at least part of the information in the first data portion to derive the hash value identified in the second data portion; and
based on the derived hash value, obtaining authorization to use the information processing feature with the information processing device.

2. The method according to claim 1, wherein at least some of the feature-enabling criteria are not included in the first data portion.

3. The method according to claim 1, further comprising:
when the information processing device is authorized to use the information processing feature, using at least part of the data structure to enable the information processing feature with the information processing device.

4. The method according to claim 3, wherein the at least part of the data structure comprises a digital key.

5. The method according to claim 3, wherein the step of using at least part of the data structure comprises arranging for transfer of the digital key to a security element within the information processing device.

6. The method according to claim 4, wherein the access condition comprises a restriction regarding use of the information processing feature, the restriction represented by a Boolean expression of logical references to the feature-enabling criteria.

7. The method according to claim 6, wherein the step of obtaining authorization to use the information processing feature with the information processing device comprises:
when the derived hash value matches the hash value identified in the second data portion, evaluating the access condition; and
based on the evaluation, the security element supplying authorization to use the information processing feature.

8. The method according to claim 7, wherein the feature-enabling criteria comprise configuration data associated with the information processing device.

9. A computer-readable medium encoded with a computer program which, when loaded into a processor, implements the method of claim 1.

10. A computer-readable medium having stored thereon a data structure, the data structure usable to authorize an information processing feature for use with an information processing device, the data structure comprising:
a first data portion having information identifying the information processing feature, identifying a hash algorithm, and identifying an access condition associated with the information processing feature, the access condition usable to provide a logical reference to one or more feature-enabling criteria, each feature-enabling criteria representing a characteristic associated with the information processing device, and
a second data portion having information identifying a hash value, the hash value derived by applying the hash algorithm to at least part of the information in the first data portion and to at least some of the feature-enabling criteria, when the feature-enabling criteria are present,
wherein when the information processing device receives the data structure from a broadband communication system via a communication medium and applies the hash algorithm to at least part of the information in the first data portion and to at least some of the one or more feature-enabling criteria, when present, in such a manner that the hash value identified in the second data portion is derived, the information processing device is authorized to use the information processing feature.

11. An apparatus for authorizing use of an information processing feature with an information processing device, the apparatus comprising:
a computer-readable storage medium; and
a processor responsive to the computer-readable storage medium and to a computer program, the computer program, when loaded into the processor, operable to:
arrange for the information processing device's access to a data structure, the data structure comprising
a first data portion having information identifying the information processing feature, identifying a hash algorithm, and identifying an access condition associated with the information processing feature, the access condition usable to provide a logical reference to one or more feature-enabling criteria, each feature-enabling criteria representing a characteristic associated with the information processing device, and
a second data portion having information identifying a hash value, the hash value derived by applying the hash algorithm to at least part of the information in the first data portion and to at least some of the feature-enabling criteria, when the feature-enabling criteria are present,
when the information processing device applies the hash algorithm to at least part of the information in the first data portion and to at least some of the feature-enabling criteria, when present, in such a manner that the hash value identified in the second data portion is derived, the information processing device is authorized to use the information processing feature.

12. The apparatus according to claim 11, wherein the processor comprises a network element associated with the broadband communication system.

13. The apparatus according to claim 11, wherein the processor is associated with a consumer network device.

14. The apparatus according to claim 13, wherein the consumer network device comprises a set-top box.

15. The apparatus according to claim 11, wherein the at least part of the data structure comprises a digital key.

16. The apparatus according to claim 15, wherein the step of using at least part of the data structure comprises arranging for transfer of the digital key to a security element within the information processing device.

17. The apparatus according to claim 11, wherein at least some of the feature-enabling criteria are not included in the first data portion.

18. The apparatus according to claim 11, wherein the access condition comprises a restriction regarding use of the information processing feature.

19. The apparatus according to claim 18, wherein the restriction is represented by a Boolean expression of logical references to feature-enabling criteria.

20. The apparatus according to claim 19, wherein the feature-enabling criteria comprise configuration data associated with the information processing device.
